(19) United States
(12) Patent Application Publication
(10) Pub. No.: US 2025/0037365 A1
(43) Pub. Date: Jan. 30, 2025

(54) GENERATION DEVICE, GENERATION METHOD, AND GENERATION PROGRAM

(71) Applicant: NIPPON TELEGRAPH AND TELEPHONE CORPORATION, Tokyo (JP)

(72) Inventors: Katsuhiro SUZUKI, Tokyo (JP); Kazuya MATSUO, Tokyo (JP); Lidwina Ayu ANDARINI, Tokyo (JP); Takashi KUBO, Tokyo (JP); Toru NISHIMURA, Tokyo (JP)

(73) Assignee: NIPPON TELEGRAPH AND TELEPHONE CORPORATION, Tokyo (JP)

(21) Appl. No.: 18/716,147

(22) PCT Filed: Dec. 10, 2021
(86) PCT No.: PCT/JP2021/045624

§ 371 Date: Jun. 4, 2024

(51) Int. Cl. G06T 17/00; G06T 7/60; G06T 7/70

(52) U.S. Cl. CPC G06T 17/00; G06T 7/60; G06T 7/70; G06T 2207/10024

(57) ABSTRACT

A generation device (10) includes: a 3D reconstruction unit (12) that reconstructs an original three-dimensional image based on a plurality of images and a plurality of depth images, and acquires information indicating a position, a posture, a shape, and an appearance of a mapping target object that is a target of mapping to a digital space, and position information and posture information of an imaging device that has captured the image and the depth image; a labeling unit (13) that acquires a plurality of two-dimensional images in which labels or categories are associated with all pixels in an image based on the plurality of images; an estimation unit (14) that estimates a material and mass of the mapping target object based on the plurality of two-dimensional images and the position information and the posture information of the imaging device; and a generation unit (16) that integrates the information indicating a position, a posture, a shape, and an appearance of the mapping target object, and the information indicating the material and mass of the mapping target object, and generates digital twin data including position information, posture information, shape information, appearance information, material information, and mass information of the mapping target object.

### TECHNICAL FIELD

The present invention relates to a generation device, a generation method, and a generation program.

### BACKGROUND ART

A digital twin technology that maps an object in a real space onto a cyberspace has been realized and attracted attention according to the progress of Information and Communication Technology (ICT) (Non Patent Literature 1). A digital twin is, for example, an accurate representation of a real world object such as a production machine in a factory, an aircraft engine, or an automobile by mapping a shape, a state, a function, and the like in a cyberspace.

By using this digital twin, it is possible to perform current state analysis, future prediction, simulation of possibility, and the like regarding the object in the cyberspace. Furthermore, based on the result thereof, it is possible to feed back benefits of cyberspace, for example, benefits of easily utilizing ICT technology, such as intelligently controlling a target in the real world, to a target in the real world.

### CITATION LIST

### Non Patent Literature

Non Patent Literature 1: NTT, “DIGITAL TWIN COMPUTING”, [online], [retrieved on Dec. 3, 2021], Internet <URL: https://www.rd.ntt/dtc/DTC_Whitepaper_jp_2_0_0.pdf>

### SUMMARY OF INVENTION

### Technical Problem

In the future, as digital twinning of various objects in the real world progresses, it is assumed that the demand for cooperation between industries and large-scale simulation will increase through the interaction and combination of different and various digital twins across industries.

However, since a current digital twin will be created and used according to a purpose, it will be difficult to perform interaction by combining various digital twins.

The present invention has been made in view of the above, and an object thereof is to provide a generation device, a generation method, and a generation program capable of generating a general-purpose digital twin that can be used in a plurality of applications.

### Solution to Problem

In order to solve the above-described problems and achieve the object, according to the present invention, there is provided a generation device including: a reconstruction unit that reconstructs an original three-dimensional image based on a plurality of images and a plurality of depth images, and acquires information indicating a position, a posture, a shape, and an appearance of a mapping target object that is a target of mapping to a digital space, and position information and posture information of an imaging device that has captured the image and the depth image; an association unit that acquires a plurality of two-dimensional images in which labels or categories are associated with all pixels in an image based on the plurality of images; an estimation unit that estimates a material and mass of the mapping target object based on the plurality of two-dimensional images and the position information and the posture information of the imaging device; and a first generation unit that integrates the information indicating a position, a posture, a shape, and an appearance of the mapping target object acquired by the reconstruction unit, and the information indicating the material and mass of the mapping target object estimated by the estimation unit, and generates digital twin data including position information, posture information, shape information, appearance information, material information, and mass information of the mapping target object.

### Advantageous Effects of Invention

According to the present invention, a general-purpose digital twin that can be used in a plurality of applications can be generated.

### BRIEF DESCRIPTION OF DRAWINGS

FIG. 1 is a diagram for explaining digital twin data generated in an embodiment.

FIG. 2 is a diagram schematically illustrating an example of a configuration of a generation device according to the embodiment.

FIG. 3 is a diagram illustrating a positional relationship between an object and an imaging device.

FIG. 4 is a diagram illustrating a positional relationship between the object and the imaging device.

FIG. 5 is a diagram for explaining an image selected for material estimation.

FIG. 6 is a diagram for explaining an example of position information and posture information of an imaging device acquired by a three-dimensional (3D) reconstruction unit.

FIG. 7 is a diagram for explaining a material estimation result of a material estimation unit.

FIG. 8 is a diagram for explaining an estimator used by the material estimation unit.

FIG. 9 is a flowchart illustrating a processing procedure of generation processing according to the embodiment.

FIG. 10 is a diagram illustrating an example of a computer in which a program is executed to realize the generation device.

### DESCRIPTION OF EMBODIMENTS

Hereinafter, an embodiment of the present invention will be described in detail with reference to the drawings. Note that the present invention is not limited by this embodiment. In the description of the drawings, the same parts are denoted by the same reference numerals.

### EMBODIMENT

In the present embodiment, a plurality of attributes required for calculating interaction in many use cases are defined as basic attributes of the digital twin, and digital twin data having the basic attributes is generated from an image. As a result, in the present embodiment, it is possible to generate general-purpose digital twin data that can be used in a plurality of applications.

An example of a use case of the digital twin will be described. In product lifecycle management (PLM) that integrally manages information on all processes from planning to development, design, production preparation, procurement, production, sales, and maintenance, attributes such as the shape, material, and mass of the digital twin are required.

Furthermore, in virtual reality (VR) or augmented reality (AR), attributes such as the position, posture, shape, and appearance of the digital twin are required. In addition, in sports analysis, attributes such as the position, posture, and material of the digital twin are required.

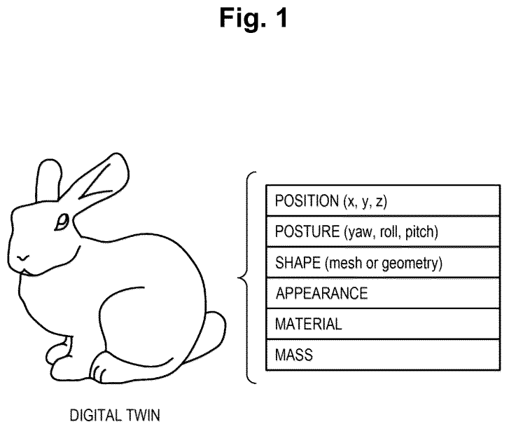

FIG. 1 is a diagram for explaining digital twin data generated in an embodiment. In the embodiment, six attributes required in typical use cases such as PLM, VR, AR, and sports analysis are selected as main parameters and defined as basic attributes of digital twin data. As illustrated in FIG. 1, in the embodiment, digital twin data including a position, a posture, a shape, an appearance, a material, and a mass of an object expressed as a digital twin as parameters is generated. Note that the digital twin data of the “rabbit” illustrated in FIG. 1 is a model called Stanford Bunny (refer to [online], [retrieved on Dec. 3, 2021], Internet <URL: http://graphics.stanford.edu/data/3Dscanrep/#bunny>).

The position is position coordinates (x, y, z) of the object that uniquely specifies the position of the object. The posture is posture information (yaw, roll, pitch) of the object that uniquely specifies the orientation of the object. The shape is mesh information or geometry information representing the three-dimensional shape to be displayed. The appearance is color information of the object surface. The material is information indicating the material of the object. The mass is information indicating the mass of the object.

In the embodiment, digital twin data including a position, a posture, a shape, an appearance, a material, and a mass is accurately generated based on an RGB image and a depth image. As a result, in the embodiment, it is possible to provide highly accurate digital twin data that can be generally used in a plurality of applications.

Furthermore, in the embodiment, metadata including the generator, the generation date and time, and the file capacity of the digital twin is assigned to the digital twin data, and accordingly, security can be maintained and appropriate management can be performed even when the digital twin data is shared by a plurality of persons.

### [Generation Device]

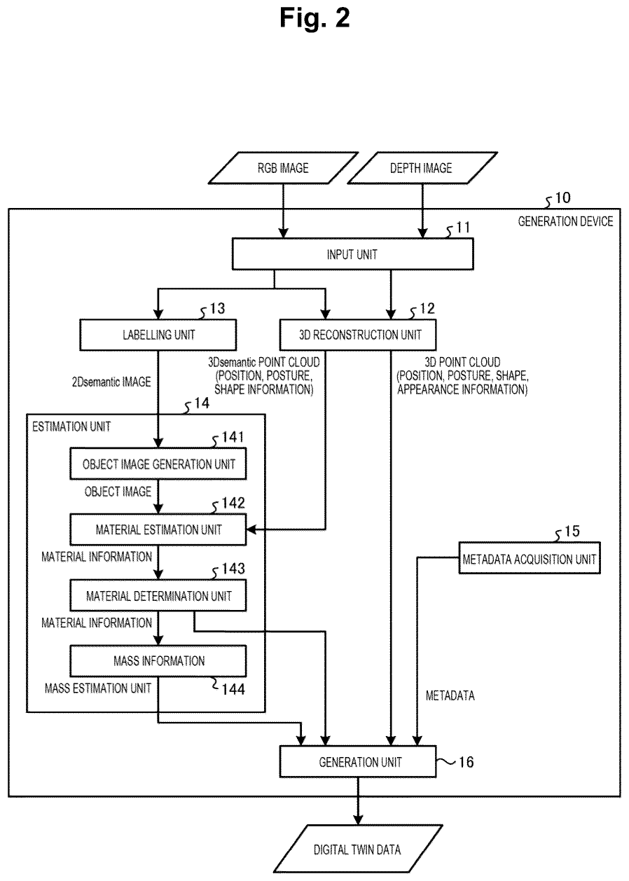

Next, a generation device according to the embodiment will be described. FIG. 2 is a diagram schematically illustrating an example of a configuration of a generation device according to the embodiment.

A generation device 10 according to the embodiment is realized when, for example, a predetermined program is read by a computer or the like including a read only memory (ROM), a random access memory (RAM), a central processing unit (CPU), and the like, and the predetermined program is executed by the CPU. Further, the generation device 10 includes a communication interface that transmits and receives various types of information to and from another device connected via a network or the like. The generation device 10 illustrated in FIG. 2 performs processing described below using the RGB image and the depth image, thereby accurately generating digital twin data which includes information of a position, a posture, a shape, an appearance, a material, and a mass and to which metadata is assigned.

The generation device 10 includes an input unit 11, a 3D reconstruction unit 12 (reconstruction unit), a labeling unit 13 (association unit), an estimation unit 14, a metadata acquisition unit (acquisition unit) 15, and a generation unit 16 (first generation unit).

The input unit 11 receives inputs of a plurality of (for example, N (N≥2)) RGB images and a plurality of (for example, N) depth images. The RGB image is an image obtained by imaging an object (mapping target object) which is a mapping target in the digital space. The depth image has data indicating a distance from a pixel of an imaging device that captures an image to an object. The RGB image and the depth image input by the input unit 11 are an RGB image and a depth image obtained by imaging the same place. The RGB image and the depth image input by the input unit 11 are associated in units of pixels input by the input unit 11 using a calibration method. It is known information that the (x₁, y₁) of the RGB image is the (x₂, y₂) of the depth image.

The N RGB images and the N depth images are captured by imaging devices installed at different positions. Alternatively, the N RGB images and the N depth images are captured by an imaging device of which positions and/or postures change at predetermined time intervals. The input unit 11 outputs the plurality of RGB images and the plurality of depth images to the 3D reconstruction unit 12. The input unit 11 outputs the plurality of RGB images to the labeling unit 13. Note that, in the present embodiment, a case where the subsequent processing is performed using the RGB image will be described as an example, but the image used by the generation device 10 may be an image obtained by imaging the mapping target object, such as a grayscale image.

The 3D reconstruction unit 12 reconstructs the original three-dimensional image based on the N RGB images and the N depth images, and acquires information indicating the position, posture, shape, and appearance of the mapping target object which is the mapping target in the digital space. Then, the 3D reconstruction unit 12 acquires position information and posture information of the imaging device that has captured the RGB image and the depth image. The 3D reconstruction unit 12 outputs a 3D point cloud including information indicating the position, posture, shape, and appearance of the mapping target object to the generation unit 16. The 3D reconstruction unit 12 outputs position information and posture information of the imaging device that has captured the RGB image and the depth image, and information indicating the shape of the mapping target object to the estimation unit 14 as a 3D semantic point cloud. The 3D reconstruction unit 12 can use a known method as a three-dimensional image reconstruction method.

The labeling unit 13 acquires a plurality of (for example, N) 2D semantic images (two-dimensional images) in which labels or categories are associated with all pixels in the image based on a plurality of (for example, N) RGB images. Specifically, the labeling unit 13 classifies a label or a category for each pixel by performing semantic segmentation processing. The labeling unit 13 performs a semantic segmentation processing using a deep neural network (DNN) trained by deep learning.

The estimation unit 14 estimates the material and mass of the mapping target object based on a plurality of (for example, N) 2D semantic images and the position information and posture information of the imaging device acquired by the 3D reconstruction unit 12. The estimation unit 14 includes an object image generation unit 141 (second generation unit), a material estimation unit 142 (first estimation unit), a material determination unit 143 (determination unit), and a mass estimation unit 144 (second estimation unit).

The object image generation unit 141 generates a plurality of (for example, N) object images (extracted images) obtained by extracting the mapping target object based on a plurality of (for example, N) 2D semantic images. In the 2D semantic image, a label or a category such as a person, sky, sea, or background is assigned to each pixel. Therefore, it is possible to determine what kind of object is present at which position in the image from the 2D semantic image.

The object image generation unit 141 generates, for example, an object image obtained by extracting only pixels indicating a person from a 2D semantic image based on a label or a category assigned to each pixel. The object image generation unit 141 generates an object image corresponding to the mapping target object by extracting pixels to which a label or a category corresponding to the mapping target object is assigned from the 2D semantic image.

The material estimation unit 142 extracts two or more object images including the same mapping target object from a plurality of (for example, N) object images based on the position information and posture information of the imaging device, and estimates the material for each mapping target object included in the extracted two or more extracted images. Note that there is a case where the object is made of a material different for each part, but the material estimation unit 142 can estimate the material in units of pixels or parts even in such a case.

In material estimation, an image or a 3D point cloud is generally used as an input. When using a 3D point cloud, a 3D point cloud of an object must be provided. Therefore, it has been necessary to image only a single object by, for example, spreading white cloth on the background. In addition, the 3D point cloud has a problem that information other than the feature point is missing depending on the method of selecting the feature point, and the information amount is smaller than that in the case of using the RGB image.

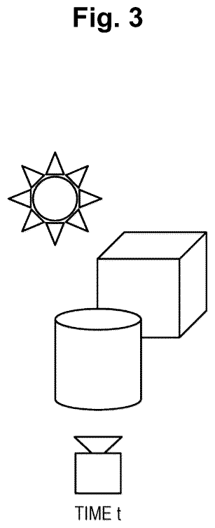

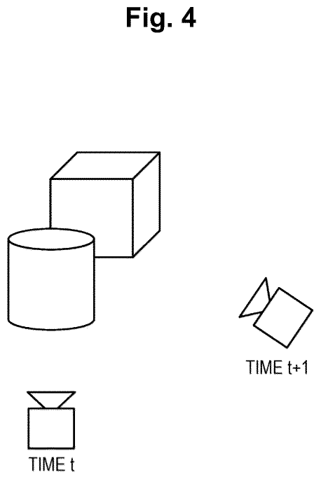

FIGS. 3 and 4 are diagrams illustrating a positional relationship between the object and the imaging device. However, when an RGB image is used, a correct material may not be known due to occlusion or reflection of light. For example, in a case where the light is back light (FIG. 3) or in a case where the object at the back is hidden behind the object at the front (the position of the imaging device at time t in FIG. 4), the correct material of the object cannot be estimated.

However, in a case where the imaging positions and postures of the imaging devices are different (for example, the imaging position at time t+1 in FIG. 4), both of the two objects can be imaged. Therefore, the estimation unit 14 searches for an object image including the same object positioned at the same place in the image from the position information and the posture information of the imaging device. Then, the estimation unit 14 performs material estimation for each of two or more object images including the same object, and obtains an average of two or more estimation results, thereby acquiring a more accurate material estimation result.

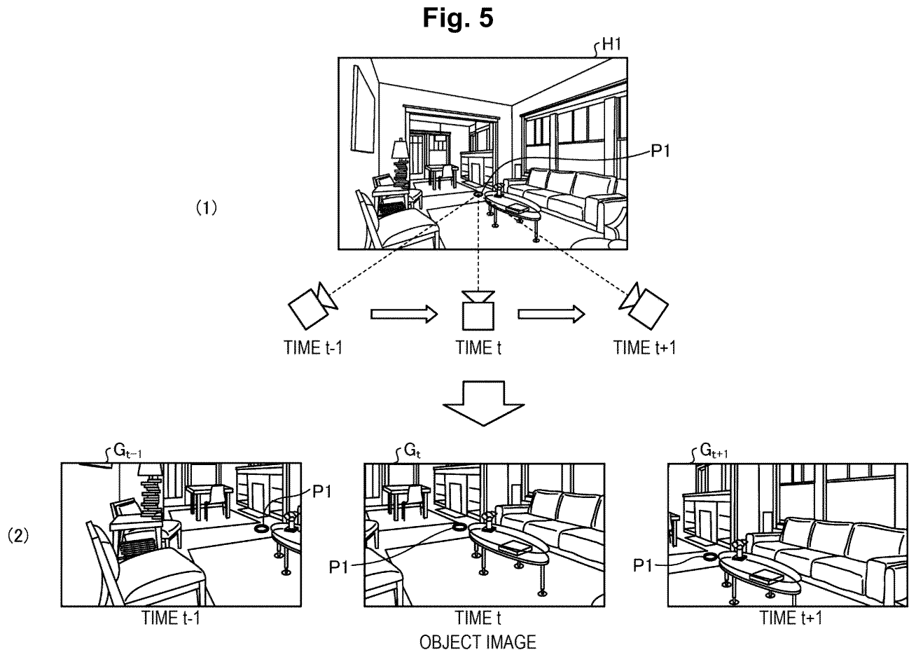

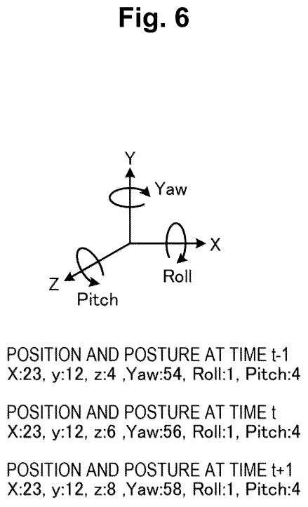

FIG. 5 is a diagram for explaining an image selected for material estimation. FIG. 6 is a diagram for explaining an example of the position information and posture information of an imaging device acquired by the 3D reconstruction unit 12. In FIGS. 5 and 6, for example, a case where material estimation of an object positioned at a position P1 of an indoor H1 is performed is taken as an example.

For example, the material estimation unit 142 determines the time when the imaging device has imaged the position P1 based on the position information and posture information of the imaging device illustrated in FIG. 6. In the case of the examples of FIGS. 5 and 6, the imaging device images the position P1 from different angles at different time t−1, time t, and time t+1. Note that the images captured at time t−1, time t, and time t+1 are each captured in a continuous short span, and there is little change in the image. Furthermore, the objects shown in the images captured at time t−1, time t, and time t+1 are associated with each other. In addition, it is known information that the (x₁, y₁) of the image at time t−1 is the (x₂, y₂) of the image at time t.

With respect to the position P1, the material estimation unit 142 extracts an object image Gₜ₋₁ based on an RGB image captured at time t−1, an object image Gₜ based on an RGB image captured at time t, and an object image Gₜ₊₁ based on an RGB image captured at time t+1 from N object images generated by the object image generation unit 141.

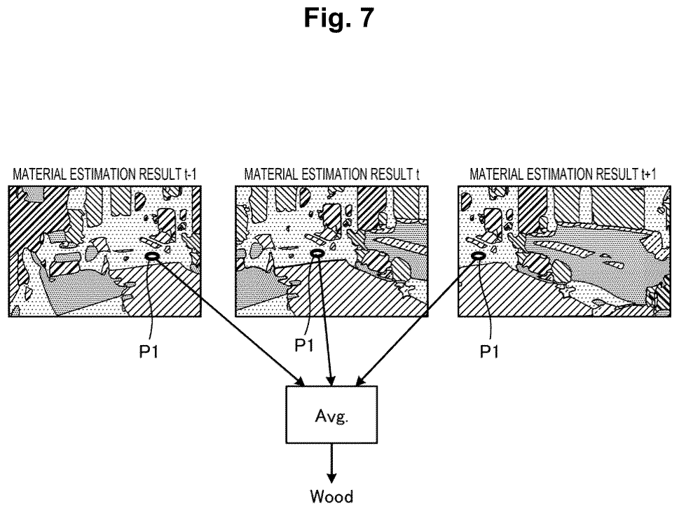

FIG. 7 is a diagram for explaining a material estimation result of the material estimation unit 142. As illustrated in FIG. 7, the material estimation unit 142 performs material estimation for each object included in the object images Gₜ₋₁, Gₜ, and Gₜ₊1.

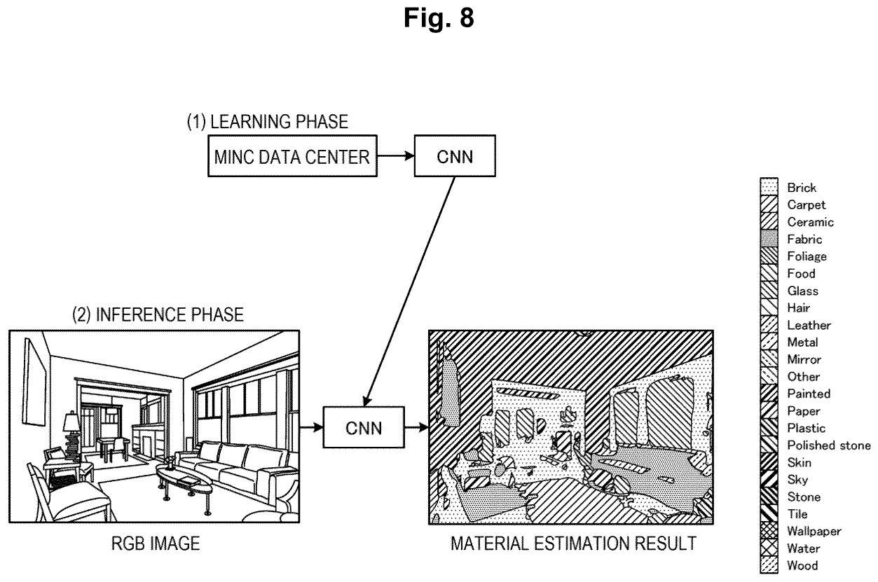

FIG. 8 is a diagram for explaining an estimator used by the material estimation unit 142. As illustrated in FIG. 8, the estimator used by the material estimation unit 142 is, for example, a convolutional neural network (CNN) learned by creating or using a materials in context (MINC) data set. The MINC data set is an RGB image group in which materials (for example, 23 types of Brick, Carpet, Ceramic, Fabric, Foliage, Food, Glass, Hair, Leather, Metal, Mirror, Other, Painted, Paper, Plastic, Pol.stone, Skin, Sky, Tile, Wallpaper, Water, and Wood) of a plurality of materials are labeled.

When an RGB image is input by learning the MINC data set ((1) in FIG. 8), the estimator estimates a material of an object appearing in the RGB image and outputs an estimation result ((2) in FIG. 8).

Note that the material estimation unit 142 may extract two or more object images based on two or more RGB images obtained by imaging the same mapping target object from different angles. Note that the material estimation unit 142 may extract two or more object images based on two or more RGB images obtained by imaging the mapping target object from different dates and times.

The material determination unit 143 performs statistical processing on the material information of each mapping target object estimated by the material estimation unit 142, and determines the material of the mapping target object included in the object image based on the result of the statistical processing. The material determination unit 143 performs material estimation for each of two or more object images including the same mapping target object, and determines the material of the mapping target object based on statistical processing results for two or more material estimation results for the same mapping target object.

For example, as illustrated in FIG. 7, the material determination unit 143 obtains an average (for example, Wood) of the estimation results of the objects appearing at the position P1 of the object images Gₜ₋₁, Gₜ, and Gₜ₊1, and outputs the average as the material of the object appearing at the position P1. Alternatively, the material determination unit 143 may output, for example, a material that accounts for 60% of the estimation result of the object appearing at the position P1 of the object images Gₜ₋₁, Gₜ, and Gₜ₊1 as the material of the object appearing at the position P1. The number of object images which is an estimation target is not limited to three, and may be two or more.

The material determination unit 143 estimates the material based on two or more object images including the mapping target object imaged at different angles and/or dates and times, and accordingly, the estimation accuracy can be secured even in a case where an object image in which the material cannot be estimated is included. The material determination unit 143 outputs information indicating the determined material of the mapping target object to the generation unit 16 and the mass estimation unit 144.

The mass estimation unit 144 estimates the mass of the mapping target object based on the material of the mapping target object and the volume of the mapping target object determined by the material determination unit 143. The volume of the mapping target object can be calculated based on the position, posture, and shape information of the mapping target object acquired by the 3D reconstruction unit 12. The mass of the mapping target object can be calculated using the image2mass method (Reference Literature 1). The mass estimation unit 144 outputs information indicating the estimated mass of the mapping target object to the generation unit 16.

Reference Literature: Trevor Standley, et. al, “image2mass: Estimating the Mass of an Object from Its Image”, Proceedings of Machine Learning Research, Vol. 78, [online], [searched on Dec. 3, 2021], Internet <URL: http://proceedings.mlr.press/v78/standleyl7a.html>

Note that the estimation unit 14 may further secure the estimation accuracy of the material and mass by comparing the shape information calculated based on the material and mass estimated by the estimation unit 14 with the shape information of the mapping target object acquired by the 3D reconstruction unit 12.

For example, in a case where the matching degree between the shape information calculated based on the material and the mass estimated by the estimation unit 14 and the shape information of the mapping target object acquired by the 3D reconstruction unit 12 satisfies a predetermined criteria, the estimation unit 14 outputs the material information and the mass information. On the other hand, when the matching degree does not satisfy the predetermined criteria, the estimation unit 14 determines that the accuracy of the material information and the mass information is not secured, returns to the material estimation processing, and estimates the material and the mass again.

The metadata acquisition unit 15 acquires metadata including the generator, the generation date and time, and the file capacity of the digital twin data as metadata, and outputs the metadata to the generation unit 16. For example, the metadata acquisition unit 15 acquires the metadata based on the log data and the like of the generation device 10. The metadata acquisition unit 15 may acquire data other than the above as metadata.

The generation unit 16 integrates the information indicating the position, posture, shape, and appearance of the mapping target object acquired by the 3D reconstruction unit 12 and the information indicating the material and mass of the mapping target object estimated by the estimation unit 14, and generates digital twin data including position information, posture information, shape information, appearance information, material information, and mass information of the mapping target object. The generation unit 16 assigns the metadata acquired by the metadata acquisition unit 15 to the digital twin data. Then, the generation unit 16 outputs the generated digital twin data.

Therefore, when receiving the plurality of RGB images and the depth image as inputs, the generation device 10 outputs digital twin data including the position information, the posture information, the shape information, the appearance information, the material information, and the mass information of the mapping target object, the digital twin data to which the metadata is assigned.

### [Processing Procedure of Generation Processing]

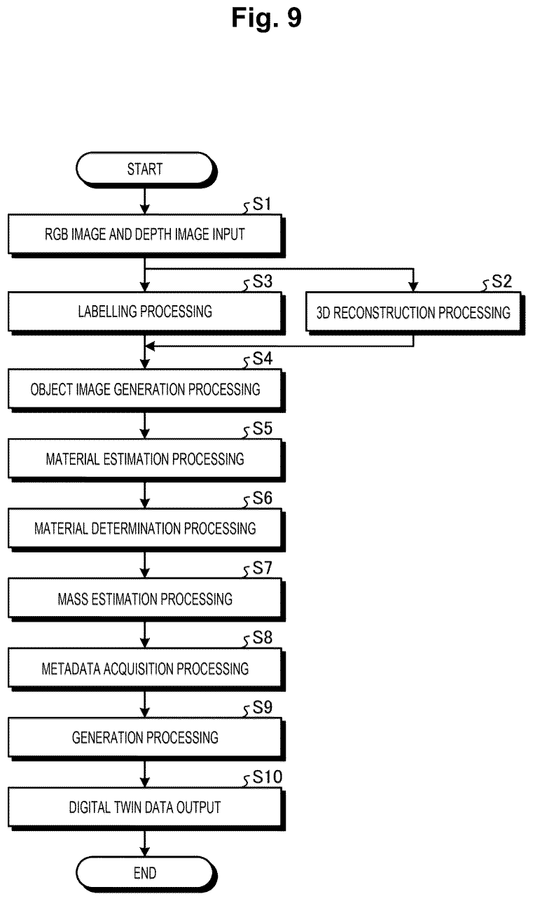

Next, generation processing according to the embodiment will be described. FIG. 9 is a flowchart illustrating a processing procedure of generation processing according to the embodiment.

As illustrated in FIG. 9, in the generation device 10, the input unit 11 receives inputs of N RGB images and N depth images (step S1). Subsequently, the 3D reconstruction unit 12 performs reconstruction processing of reconstructing the original three-dimensional image based on the N RGB images and the N depth images (step S2). The 3D reconstruction unit 12 acquires information indicating the position, posture, shape, and appearance of the mapping target object, and acquires position information and posture information of the imaging device that has captured the RGB image and the depth image.

The labeling unit 13 performs labeling processing of acquiring N 2D semantic images in which labels or categories are associated with all pixels in the image based on the N RGB images (step S3). Steps S2 and S3 are processed in parallel.

The object image generation unit 141 performs object image generation processing of generating N object images obtained by extracting the mapping target objects based on the N 2D semantic images (step S4).

The material estimation unit 142 performs the material estimation processing of extracting two or more object images including the same mapping target object from the N object images based on the position information and posture information of the imaging device, and estimating the material for each mapping target object included in the two or more extracted images (step S5).

The material determination unit 143 performs statistical processing on the material information of each mapping target object included in the object image estimated by the material estimation unit 142, and performs the material determination processing of determining the material of the mapping target object included in the object image based on the result of the statistical processing (step S6).

The mass estimation unit 144 performs the material estimation processing of estimating the mass of the mapping target object based on the material of the mapping target object and the volume of the mapping target object determined by the material determination unit 143 (step S7).

The metadata acquisition unit 15 performs metadata acquisition processing of acquiring metadata including the generator, the generation date and time, and the file capacity of the digital twin as metadata (step S8).

The generation unit 16 generates digital twin data including position information, posture information, shape information, appearance information, material information, and mass information of the mapping target object, and performs generation processing of assigning metadata to the digital twin data (step S9). The generation device 10 outputs the digital twin data generated by the generation unit 16 (step S10), and ends the processing.

### Effects of Embodiment

As described above, in the embodiment, the position information, the posture information, the shape information, the appearance information, the material information, and the mass information of the mapping target object are defined as the main parameters of the digital twin. Then, when the RGB image and the depth image are input, the generation device 10 according to the embodiment outputs digital twin data having position information, posture information, shape information, appearance information, material information, and mass information of the mapping target object as attributes. These six attributes are parameters required for a plurality of typical applications such as PLM, VR, AR, and sports analysis.

Therefore, the generation device 10 can provide digital twin data that can be used for general purposes among a plurality of applications. Therefore, it is also possible to perform interaction by multiplying the digital twin data provided by the generation device 10, and it is possible to realize flexible use of the digital twin data.

Then, in the generation device 10, the estimation unit 14 performs material estimation based on two or more object images including the same mapping target object based on a plurality of RGB image groups and the position information and posture information of the imaging device in which the plurality of RGB image groups are captured. Then, the estimation unit 14 determines the material of the mapping target object based on the statistical processing result for two or more material estimation results for the same mapping target object.

Therefore, the generation device 10 estimates the material based on two or more object images including the mapping target object imaged at different angles and/or dates and times, and accordingly, the estimation accuracy can be secured even in a case where an object image in which the material cannot be estimated is included. Then, the estimation unit 14 estimates the mass of the mapping target object based on the estimated material of the mapping target object. Therefore, the generation device 10 can provide the digital twin data expressing the material and the mass with high accuracy, which has been difficult to secure the accuracy so far, and can also support the application using the material.

Furthermore, the generation device 10 assigns the metadata such as the generator, the generation date and time, and the file capacity of the digital twin to the digital twin data, and accordingly, security can be maintained and appropriate management can be performed even when the digital twin data is shared by a plurality of persons.

### Regarding System Configuration of Embodiment

Each component of the generation device 10 is functionally conceptual, and does not necessarily have to be physically configured as shown in the drawings. That is, specific forms of distribution and integration of the functions of the generation device 10 are not limited to the illustrated forms, and all or a part thereof can be functionally or physically distributed or integrated in any unit according to various loads, usage conditions, and the like.

Moreover, all or any part of processing performed in the generation device 10 may be realized by a CPU, a graphics processing unit (GPU), or a program analyzed and executed by the CPU or the GPU. Moreover, each processing performed in the generation device 10 may be realized as hardware by wired logic.

Moreover, among the pieces of processing described in the embodiment, all or a part of the processing described as being automatically performed can be manually performed. Alternatively, all or a part of the processing described as being manually performed can be automatically performed by a known method. In addition, the above-described and illustrated processing procedures, control procedures, specific names, and information including various data and parameters can be appropriately changed unless otherwise specified.

### [Program]

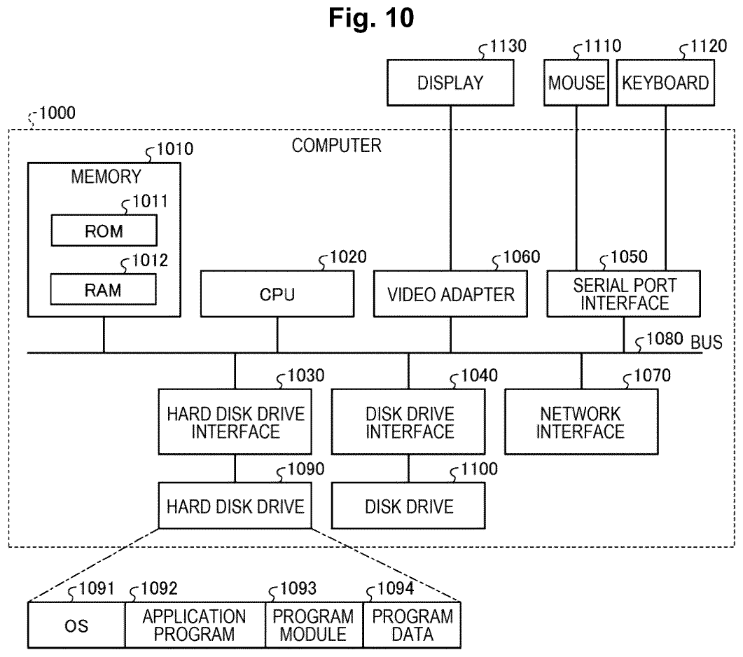

FIG. 10 is a diagram illustrating an example of a computer in which a program is executed to realize the generation device 10. A computer 1000 includes a memory 1010 and a CPU 1020, for example. Furthermore, the computer 1000 includes a hard disk drive interface 1030, a disk drive interface 1040, a serial port interface 1050, a video adapter 1060, and a network interface 1070. These units are connected via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to a mouse 1110 and a keyboard 1120, for example. The video adapter 1060 is connected to a display 1130, for example.

The hard disk drive 1090 stores, for example, an operating system (OS) 1091, an application program 1092, a program module 1093, and program data 1094. That is, a program that defines each processing of the generation device 10 is installed as a program module 1093 in which a code executable by the computer 1000 is described. The program module 1093 is stored in, for example, the hard disk drive 1090. For example, the program module 1093 for executing similar processing to the functional configurations in the generation device 10 is stored in the hard disk drive 1090. Note that the hard disk drive 1090 may be replaced with a solid state drive (SSD).

Furthermore, setting data used in the processing of the above-described embodiment is stored as the program data 1094, for example, in the memory 1010 or the hard disk drive 1090. The CPU 1020 then reads the program module 1093 and the program data 1094 stored in the memory 1010 or the hard disk drive 1090 into the RAM 1012 as necessary and executes the program module 1093 and the program data 1094.

Further, the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from the another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art or the like based on the present embodiment are all included in the scope of the present invention.

Reference Signs List

| | |
|---|---|
| 10 | Generation device |
| 11 | Input unit |
| 12 | 3D reconstruction unit |
| 13 | Labeling unit |
| 14 | Estimation unit |
| 15 | Metadata acquisition unit |
| 16 | Generation unit |
| 141 | Object image generation unit |
| 142 | Material estimation unit |
| 143 | Material determination unit |
| 144 | Mass estimation unit |

1. A generation device comprising:
a reconstruction unit that reconstructs an original three-dimensional image based on a plurality of images and a plurality of depth images, and acquires information indicating a position, a posture, a shape, and an appearance of a mapping target object that is a target of mapping to a digital space, and position information and posture information of an imaging device that has captured the image and the depth image;
an association unit that acquires a plurality of two-dimensional images in which labels or categories are associated with all pixels in an image based on the plurality of images;
an estimation unit that estimates a material and mass of the mapping target object based on the plurality of two-dimensional images and the position information and the posture information of the imaging device; and
a first generation unit that integrates the information indicating a position, a posture, a shape, and an appearance of the mapping target object acquired by the reconstruction unit, and the information indicating the material and mass of the mapping target object estimated by the estimation unit, and generates digital twin data including position information, posture information, shape information, appearance information, material information, and mass information of the mapping target object.

2. The generation device according to claim 1, wherein
the estimation unit includes
a second generation unit that generates a plurality of extracted images obtained by extracting the mapping target object based on a plurality of the two-dimensional images,
a first estimation unit that extracts two or more of the extracted images including the same mapping target object from the plurality of extracted images based on position information and posture information of the imaging device, and estimates a material for each of the mapping target objects included in the two or more extracted images,
a determination unit that performs statistical processing on the material information of each mapping target object estimated by the first estimation unit, and determines the material of the mapping target object based on a result of the statistical processing, and
a second estimation unit that estimates the mass of the mapping target object based on a material of the mapping target object and a volume of the mapping target object determined by the determination unit.

3. The generation device according to claim 1 or 2, further comprising:
an acquisition unit that acquires metadata including a generator, a generation date and time, and a file capacity of the digital twin data as metadata, wherein
the first generation unit assigns the metadata acquired by the acquisition unit to the digital twin data.

4. A generation method executed by a generation device, the method comprising:
a step of reconstructing an original three-dimensional image based on a plurality of images and a plurality of depth images, and acquiring information indicating a position, a posture, a shape, and an appearance of a mapping target object that is a target of mapping to a digital space, and position information and posture information of an imaging device that has captured the image and the depth image;
a step of acquiring a plurality of two-dimensional images in which labels or categories are associated with all pixels in an image based on the plurality of images;
a step of estimating a material and mass of the mapping target object based on the plurality of two-dimensional images and the position information and the posture information of the imaging device; and
a step of integrating the information indicating a position, a posture, a shape, and an appearance of the mapping target object, and the information indicating the material and mass of the mapping target object, and generating digital twin data including position information, posture information, shape information, appearance information, material information, and mass information of the mapping target object.

5. A generation program for causing a computer to function as the generation device according to any one of claims 1 to 3.
